(19) United States
(12) Patent Application Publication
(10) Pub. No.: US 2009/0302561 A1
(43) Pub. Date: Dec. 10, 2009

(54) WHEEL SINKAGE PREVENTION FOR VEHICLES

(76) Inventor: Dany PINET, Saint-Honore (CA)

Correspondence Address: OGILVY RENAULT LLP, 1, Place Ville Marie, SUITE 2500, MONTREAL, QC, H3B 1R1, CA

(21) Appl. No.: 12/258,644

(22) Filed: Oct. 27, 2008

Related U.S. Application Data
(60) Provisional application No. 61/059,357, filed on Jun. 6, 2008.

(51) Int. Cl. B62B 19/02

(52) U.S. Cl. 280/28.16

(57) ABSTRACT

Herein disclosed, a pair of anti-sinkage devices having runners and being rotatably mountable to corresponding hubs of two transversally opposite wheels of a motorized vehicle in a manner that the runners can maintain their attitude and position although the wheel rotates. The anti-sinkage devices can thus limit sinkage of the wheels in sinking terrain, which can allow a broader use of ATV's during the winter season, for example.

### CROSS-REFERENCE TO RELATED APPLICATIONS

This application claims priority of U.S. Provisional Patent Application No. 61/059,357, filed Jun. 6, 2008, the contents of which are hereby incorporated.

### BACKGROUND

The specification relates to a device and method for preventing the sinkage, also known as bogging, of a motorized vehicle in sinking terrain such as snow, bog, and sand, for example.

### SUMMARY

In accordance with one aspect, there is provided a pair of anti-sinkage devices having runners and being mountable to corresponding hubs of two transversally opposite wheels of a motorized vehicle in a manner that the runners can maintain their attitude although the wheel rotates, and which can allow a broader use of ATV's during the winter season, for example.

In accordance with one aspect, there is provided a pair of anti-sinkage devices for use with two transversally opposite wheels of a motorized vehicle, each anti-sinkage device of the pair comprising a frame having a front end opposite a rear end, a wheel mount externally mountable to a corresponding one of the two wheels, a rotary connection having a transversally-oriented rotation axis rotatably connecting the wheel mount to the frame between the front end and the rear end thereof, a front runner at the front end, a rear runner at the rear end, the front runner and rear runner being aligned on a common runner plane, the common runner plane being radially offset from the axis of the rotary connection by a radial distance which is operatively lesser than a radius of the corresponding wheel, and a spacing between the front runner and the rear runner receiving the corresponding wheel at least partially therein and the axis of the rotary connection coincides with an axis of the corresponding wheel when the anti-sinkage device is mounted to the corresponding wheel.

In accordance with another aspect, there is provided an anti-sinkage device for a wheel of a motorized vehicle, the anti-sinkage device comprising a frame having a front end opposite a rear end, a wheel mount externally mountable to the wheel of the vehicle, a rotary connection having a transversally-oriented rotation axis rotatably connecting the wheel mount to the frame, a front runner at the front end, a rear runner at the rear end, the front runner and rear runner being aligned on a common runner plane, the common runner plane being radially offset from an axis of the rotary connection by a radial distance which is operatively lesser than a radius of the wheel, and a spacing between the front runner and the rear runner receiving the wheel therein when the anti-sinkage device is mounted to the wheel, whereby, during use with the anti-sinkage device mounted to the wheel, the wheel rotates about the rotary connection.

In accordance with another aspect, there is provided an anti-sinkage device for a wheel of a motorized vehicle, the anti-sinkage device comprising a runner having a front end opposite a rear end, a wheel mount externally mountable to the wheel of the vehicle, a rotary connection having a transversally-oriented rotation axis rotatably connecting the wheel mount to the runner, the runner having a runner plane being radially offset from an axis of the rotary connection by a radial distance which is operatively lesser than a radius of the wheel, whereby, during use with the anti-sinkage device mounted to the wheel, the wheel rotates about the rotary connection thereby allowing the runner to maintain a given attitude..

In accordance with another aspect, there is provided an anti-sinkage device for a wheel of a vehicle, the anti-sinkage device comprising a frame having a front end opposite a rear end, a front runner at the front end, a rear runner at the rear end, the front runner and rear runner being aligned on a common runner plane, a rotary mount located between the front end and the rear end mountable to a hub of the vehicle to maintain the anti-sinkage device at a fixed given position relative to the wheel, in which given position the runner plane is radially offset from an axis of the wheel by a radial distance which is operatively lesser than a radius of the wheel, and a spacing between the front runner and the rear runner at least partially receiving the wheel when the anti-sinkage device is in the given position..

In accordance with another aspect, there is provided a pair of anti-sinkage devices as described above, the anti-sinkage devices being mirror images of one another and being for use, respectively, on transversally opposite wheels of a vehicle.

In accordance with another aspect, there is provided the use of a pair of anti-sinkage devices on corresponding front wheels of a motorized vehicle.

In accordance with another aspect, there is provided a motorized vehicle having a pair of anti-sinkage devices on corresponding front wheels thereof.

### DESCRIPTION OF THE FIGURES

In the appended figures,

FIG. 1 is a side elevation view showing an example of an anti-sinkage device mounted on a vehicle;

FIG. 2 is an exploded perspective view of the device of FIG. 1;

FIG. 3 is a cross-sectional view taken along lines 3-3 of FIG. 2, shown unexploded; and

FIG. 4 is a perspective view showing a pair of anti-sinkage devices mounted on corresponding transversally-opposite wheels of a vehicle.

### DETAILED DESCRIPTION

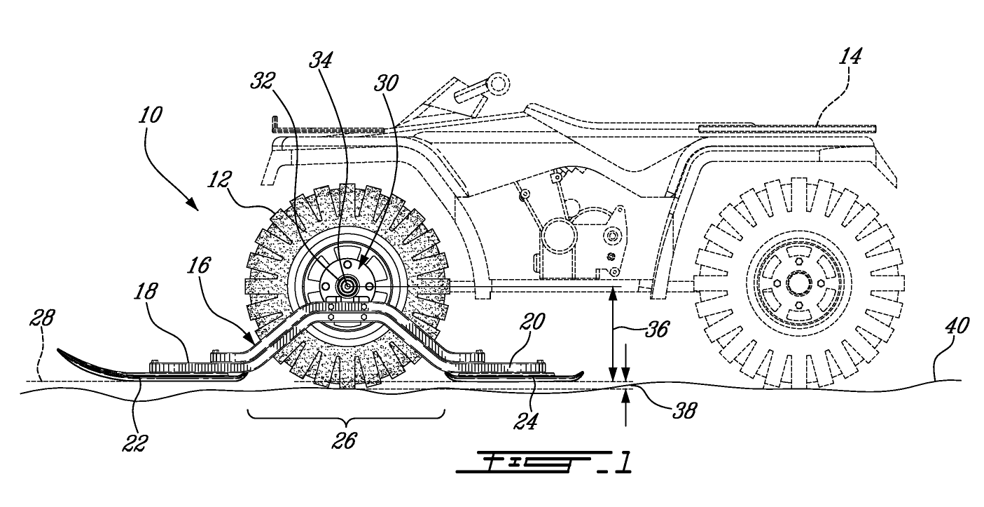

FIG. 1 shows an example of an anti-sinkage device 10. The anti-sinkage device 10 is mounted on a wheel 12 of a vehicle 14. The anti-sinkage device 10 can be seen to include a frame 16 having a front end 18 and a rear end 20. A front runner 22 is mounted to the front end 18, and a rear runner 24 is mounted to the rear end 20 of the frame 16, with a spacing 26 between the front runner 22 and the rear runner 24. Both of the front runner 22 and the rear runner 24 are aligned on a common runner plane 28.

In this example, the anti-sinkage device 10 is mounted and maintained in a given position relative to the wheel 12 by a wheel mount 30 which is connected to the wheel 12, more precisely to the hub (not shown), in a manner to rotate with the wheel 12 and hub during use of the vehicle. The frame 16 is mounted to the wheel mount 30 via a rotary connection 32, which allows relative rotation between the wheel 12 and the frame 16, in a manner that the attitude of the runner plane 28 can remain substantially horizontal during rotation of the wheel 12.

When the anti-sinkage device 10 is mounted to the vehicle 14 in the given position, the wheel 12 is received in the spacing 26 between the front runner 22 and rear runner 24, the front runner 22 and rear runner 24 can thus be at least partially aligned with the travelling path of the wheel 12, and even centrally aligned relative to the path of the wheel 12, if desired. The rotary connection 32 has a transversal rotation axis 34 which coincides with the rotation axis of the wheel 12 and hub. The runner plane 28 is spaced, or offset, from the axis 34 by a radial distance 36 which is lesser than the radius of the wheel by a wheel excess distance 38, in a manner that during use on a given type of terrain 40, the runners 22, 24 normally remain out from gliding contact with the terrain (except for the tip of the front runner), but if wheel sinkage exceeding a given sinkage threshold, corresponding to the wheel excess distance 38, occurs, the runners 22, 24 can come into gliding contact with the terrain 40 and prevent further sinkage of the wheel 12.

In this example, during use, the attitude of the runner plane 28 remains in fact slightly off perfect horizontal, and the front end of the front runner 22 normally remains in contact with the terrain, due a slight but inevitable amount of friction occurring in the rotary connection 32 and to the weight balance of the front runner 22 and the rear runner 24 relative to the pivotal connection 32. This type of contact which can be referred to as runner tip contact is normal and is not encompassed by the meaning of the expression gliding contact as defined herein, which refers to gliding contact of sliding surface along the length of the runner plane which occurs in the event of wheel sinkage exceeding the given sinkage threshold.

In view of alternate embodiments, the greater the radial distance 36 is made, the smaller the sinkage threshold before the runners 22, 24 come into the gliding contact with the terrain 40, which contributes to the efficiency, or operability of the device 10. However, the radial distance 36 should not be made too close to the radius of the wheel because a lesser wheel excess distance 38 typically translates into a lesser traction of the wheel during a wheel sinkage event. The expression “operable” is used herein to qualify a choice of relative radial distance 36 vs. wheel radius which suitably compromises sinkage threshold and tire traction during sinkage. Typically, the sinkage threshold 38 is made greater than the sum of a predetermined normal roughness of the given type of terrain 40 and a sinkage depth which can be considered normal given the type of terrain 40. Henceforth, the radial offset distance 36 can be made operatively smaller than the tire radius to provide an anti-sinkage device in which the runner normally remains out from the gliding contact with the terrain and which provides for sufficient wheel traction when the gliding contact occurs, while providing a sinkage threshold which is satisfactorily low so that the anti-sinkage device can come into operation before an excessive sinkage. Further, it has been found that increasing the radial distance 36 within a certain extent generally results in a smoother ride. However, increasing the radial distance 36 too much can result in an unpleasing driving sensation of continuous friction or gliding contact by the runners. For illustrative purposes, in the example described above and illustrated, a wheel excess distance 38 of about 3 inches was very satisfactory for the application of an ATV running on snow with a wheel having a wheel radius of 12.5 inches and given type of tire thread, whereas a wheel excess distance 38 of about ½ inch was judged unsatisfactory.

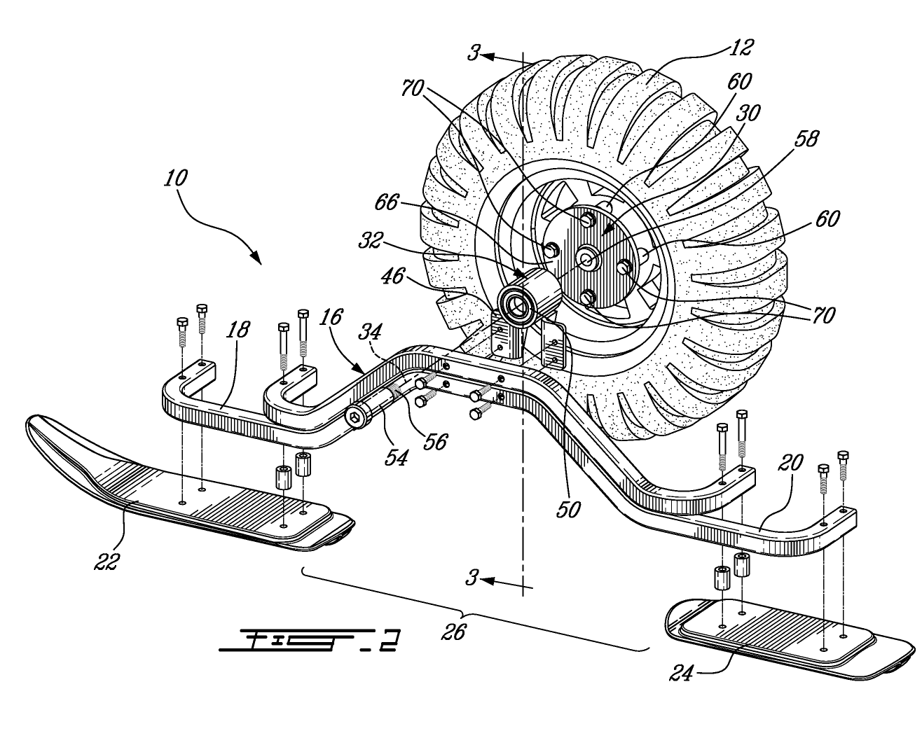

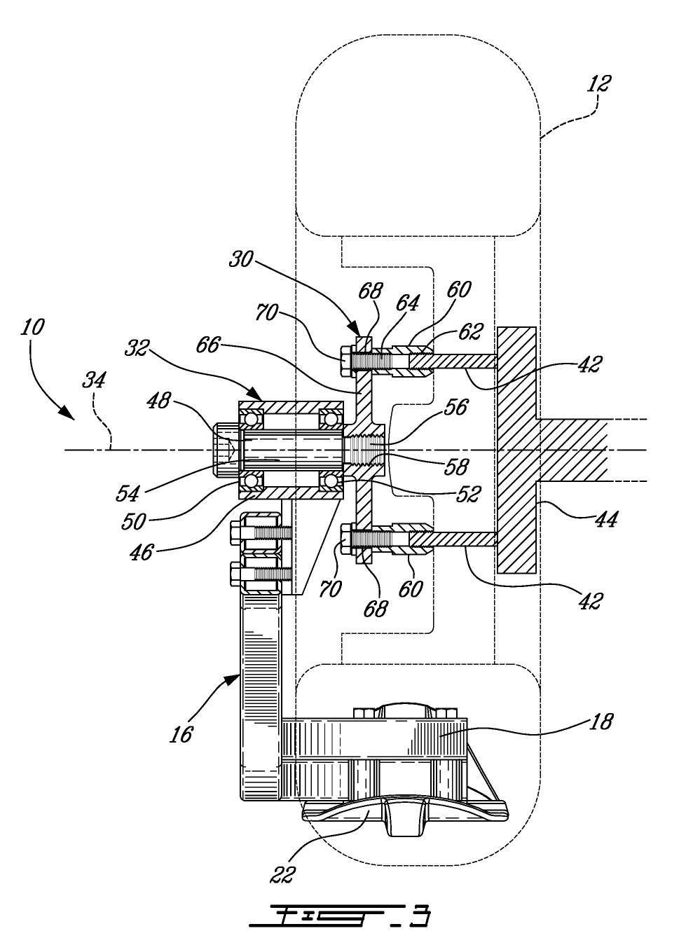

In the exploded view of FIG. 2, and the cross-sectional view of FIG. 3, the various components of this example of an anti-sinkage device 10 are shown in greater detail. In this example, the wheel mount 30 is mounted directly to the hub bolts 42 of the hub 44. The rotary connection 32 includes an outer portion 46 which is connected to the frame 16 and an inner portion 48 which is connected to the wheel mount 30. In this example, two ball bearings 50, 52 are used within the outer portion, and a shaft 54 having a threaded end 56, is inserted through the ball bearings 50, 52, and threaded into a threaded bore 58 provided in the wheel mount 30.

As it will be understood by those skilled in the art, because a user may need to remove the anti-sinkage device 10 from the wheel regularly, it is preferable that the anti-sinkage device 10 be configured to allow easy removal of the runners 22, 24 and frame 16 from the wheel 12, without having to dismount the wheel 12 from the hub 44. In this example, this is provided with the single central shaft 54 of the rotary connection 32 which is also a fastener having a threaded end 56 which is detachable from the wheel mount 30, while the wheel mount 30 can remain permanently fastened to the wheel 12 and the hub 44. In this example, the removal of the frame and runners from the wheel mount 30 is thus achieved by disassembling the rotary connection 32.

It was found experimentally that to obtain a smooth ride with the anti-sinkage device 10, the components which rotate with the wheel should be well balanced. This includes having a relatively precise alignment, or coincidence, between the axis 34 of the rotary connection and the axis of the wheel hub, and an evenly distributed weight of the wheel mount about these coinciding axes.

In this example, it will be understood that the motorized vehicle 14 is of a type having four hub bolts 42 extending from the hub 44 across the wheel 12 and by which the wheel 12 is normally fastened to the hub 44. In alternate embodiments, alternate vehicles can have more than four hub bolts as known to those skilled in the art, and the wheel mount can be adapted accordingly. In this example therefore, the wheel mount thus includes four extension nuts 60, each extension nut 60 being securably threaded onto a corresponding hub bolt 42, similarly to how a hub bolt nut is normally used. However, each extension nut 60 has two opposite threaded ends 62, 64. The wheel mount 30 also includes a central disk 66 having the central threaded bore 58 and four secondary bores 68. Four extension bolts 70 are provided to secure the disk 66 to the extension nuts 60 by insertion through the corresponding secondary bore 68 and threading into the exposed threaded end 64 of the corresponding extension nut 60, opposite the hub bolt 42. The disk 66 can thus remain permanently attached to the wheel 12 and hub 44, whereas the rotary connection 32, the frame 16 and the runners 22, 24 can be removed from the disk 66 by removing the central shaft 54. Alternate configurations are possible as well.

Because the disc 66 has secondary bores 68 at given positions, the disc 66 is adapted to a specific wheel hub type. It is possible in alternate embodiments to make the disc 66 adaptable to different hub sizes by substituting radial slots to the secondary bores. However, this can pose a further challenge with respect to the balancing of the rotating components.

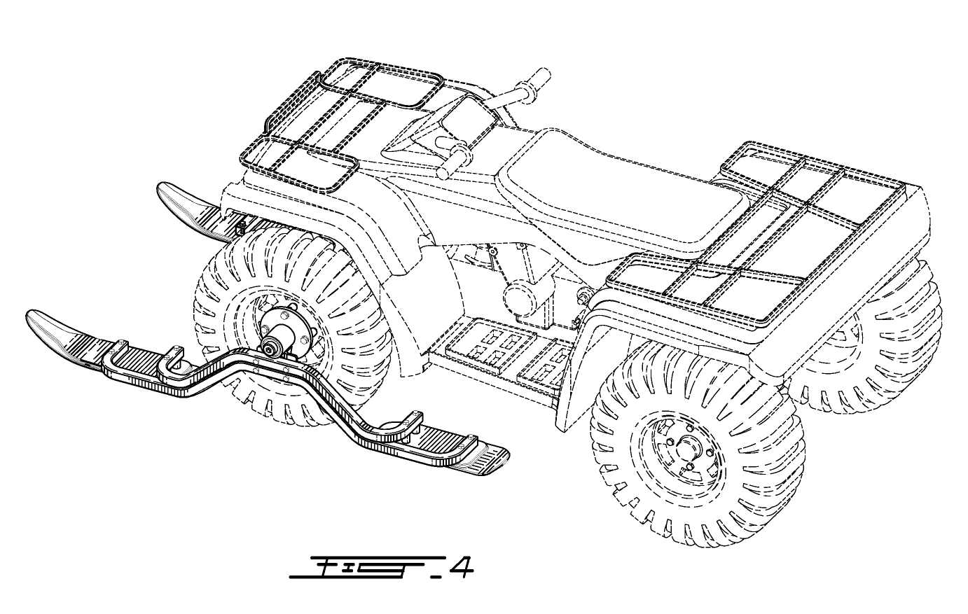

In FIG. 4, a pair of anti-sinkage devices are shown mounted in corresponding given positions on corresponding, laterally opposite wheels of a vehicle. In this example, the wheels on which the anti-sinkage devices are used, are the front, traction wheels, of the motorized vehicle.

It will be understood that the exemplary embodiment described above and illustrated, is provided for illustrative purposes only. Various alternate embodiments and variants to this exemplary embodiment can be provided in view of specific alternate embodiments. For example, the rotary connection of the anti-sinkage device can be omitted in some alternate embodiments where the anti-sinkage device is mounted to non-rotary components of the vehicle but nevertheless maintained in the given position relative to the wheel during use. For example, a pair of anti-sinkage devices can be mounted to non-rotary components of a trailer, each anti-sinkage device of the pair being associated with a corresponding wheel. This can help make the trailer more versatile and prevent sinkage thereof when pulling the loaded trailer out from snowy terrain.

Also, in alternate embodiments, the front runner and the rear runner can be provided as a front and rear portion of a single runner, without a spacing therebetween, the runner being provided adjacent the wheel instead of in the path of the wheel. The configuration of the runners themselves can vary, any suitable shape allowing to glide over the sinkable terrain can be used. In the example given above, the front runner and rear runner are provided in the form of skis, but other shapes such as sliding disks can be used as well. In the example given above, a front ski having about twice the length of the rear ski was used, though the length of the rear ski can vary between about 0.4 and 0.6 time the length of the front ski in alternate embodiments. The anti-sinkage device can be used on any desired type of vehicle which is suitable for its use. The sinkage threshold or the wheel excess distance, can vary in alternate embodiments and be adapted to specific types of terrain or to different tire thread depths. For illustrative purposes, a wheel excess distance of about 0.2 to 0.3 time the radius of the wheel was used in view of use of the anti-sinkage device with an ATV on snowy terrain. Various other variants and adaptations in view of specific applications are possible as well.

The scope is indicated by the appended claims.

What is claimed is:

1. A pair of anti-sinkage devices for use with two transversally opposite wheels of a motorized vehicle, each anti-sinkage device of the pair comprising a frame having a front end opposite a rear end, a wheel mount externally mountable to a corresponding one of the two wheels, a rotary connection having a transversally-oriented rotation axis rotatably connecting the wheel mount to the frame between the front end and the rear end thereof, a front runner at the front end, a rear runner at the rear end, the front runner and rear runner being aligned on a common runner plane, the common runner plane being radially offset from the axis of the rotary connection by a radial distance which is operatively lesser than a radius of the corresponding wheel, and a spacing between the front runner and the rear runner receiving the corresponding wheel at least partially therein and the axis of the rotary connection coincides with an axis of the corresponding wheel when the anti-sinkage device is mounted to the corresponding wheel.

2. The pair of anti-sinkage devices of claim 1 wherein the rear runners have between about 0.4 to 0.6 times the length of the front runners.

3. The pair of anti-sinkage devices of claim 2 wherein the rear runners have about 0.5 times the length of the front runners.

4. The pair of anti-sinkage devices of claim 1 wherein the frame is removable from the wheel mount.

5. The pair of anti-sinkage devices of claim 1 wherein the frame is removable from the wheel mount by disassembling the rotary connection.

6. The pair of anti-sinkage devices of claim 1 wherein the frame is removable from the wheel mount by removing a single fastener.

7. The pair of anti-sinkage devices of claim 1 wherein the runners are skis.

8. An anti-sinkage device for a wheel of a motorized vehicle, the anti-sinkage device comprising a runner having a front end opposite a rear end, a wheel mount externally mountable to the wheel of the vehicle, a rotary connection having a transversally-oriented rotation axis rotatably connecting the wheel mount to the runner, the runner having a runner plane being radially offset from an axis of the rotary connection by a radial distance which is operatively lesser than a radius of the wheel, whereby, during use with the anti-sinkage device mounted to the wheel, the wheel rotates about the rotary connection thereby allowing the runner to maintain a given attitude.

9. The anti-sinkage device of claim 8 further comprising a frame connecting the runner to the rotary connection.

10. The anti-sinkage device of claim 9 wherein the frame has a front end opposite a rear end, and the runner has a front runner portion at the front end, a rear runner portion at the rear end, and a spacing between the front runner portion and the rear runner portion, the spacing being configured and adapted to receive the wheel therein when the anti-sinkage device is mounted to the hub.

11. The anti-sinkage device of claim 10 wherein the rear runner portion has between about 0.4 to 0.6 times the length of the front runner portion.

12. The anti-sinkage device of claim 9 wherein the frame is removable from the wheel mount.

13. The anti-sinkage device of claim 9 wherein the frame is removable from the wheel mount by disassembling the rotary connection.

14. The anti-sinkage device of claim 9 wherein the frame is removable from the wheel mount by removing a single fastener.

15. The pair of anti-sinkage devices of claim 8 wherein the runner is a ski-type runner.

16. An anti-sinkage device for a wheel of a vehicle, the anti-sinkage device comprising a frame having a front end opposite a rear end, a front runner at the front end, a rear runner at the rear end, the front runner and rear runner being aligned on a common runner plane, a rotary mount located between the front end and the rear end mountable to a hub of the vehicle to maintain the anti-sinkage device at a fixed given position relative to the wheel, in which given position the runner plane is radially offset from an axis of the wheel by a radial distance which is operatively lesser than a radius of the wheel, and a spacing between the front runner and the rear runner at least partially receiving the wheel when the anti-sinkage device is in the given position.

17. The anti-sinkage device of claim 16 wherein the mount comprises a rotary connection having a transversally-oriented rotation axis rotatably connecting the mount to the frame, whereby, during use with the anti-sinkage device mounted to the hub, the wheel rotates about the rotary connection thereby allowing the runners to maintain a given attitude.

18. The anti-sinkage device of claim 16 wherein the rear runner has between about 0.4 to 0.6 times the length of the front runner.

19. The anti-sinkage device of claim 17 wherein the frame is removable from the wheel mount by disassembling the rotary connection.

20. The anti-sinkage device of claim 16 wherein the frame is removable from the wheel mount by removing a single fastener.
